(19) United States
(12) Patent Application Publication
(10) Pub. No.: US 2013/0133180 A1
(43) Pub. Date: May 30, 2013

(54) ELECTRIC VEHICLE MOTION GENERATOR

(71) Applicant: Erik James John Neis, Airdrie (CA)

(72) Inventor: Erik James John Neis, Airdrie (CA)

(21) Appl. No.: 13/306,893

(22) Filed: Nov. 29, 2011

(51) Int. Cl. B23P 11/00

(52) U.S. Cl. 29/596; 180/65.22; 903/903

(57) ABSTRACT

Regenerative braking and regenerative suspension in hybrid electric or all electric vehicles provides for an increased range by exploiting the energy previously provided to propel the vehicle to regenerate electricity to recharge the battery (or batteries) of the vehicle. Whilst suited to city and urban environments where vehicles are braking frequently there is no regeneration during prolonged propulsion of the vehicle. According to embodiments of the invention electricity generation is provided for the electricity storage during normal propulsion of the vehicle or whenever the engine/motor is on. Embodiments are presented that may be localized or distributed within the vehicle and associated with elements of the vehicle that provide rotary motion during propulsion of the vehicle.

### FIELD OF THE INVENTION

This invention relates electric vehicles and more specifically to providing a generator for recharging the electric vehicle during use.

### BACKGROUND OF THE INVENTION

The use of electricity for motive power started with a small railway operated by a miniature electric motor in 1835. In 1838 Robert Davidson built an electric locomotive that attained a speed of four miles per hour (6 km/h), and a UK patent was granted in 1840 for the use of rails as conductors of electric current, with similar first US patents issued in 1847. In the 1830s Robert Anderson invented the first crude electric carriage, powered by non-rechargeable primary cells. However, electric vehicles remained a niche solution until the late 20^{th} century where electric railway transport became commonplace, with and commercial electric automobiles increasingly common in specialist roles, such as platform trucks, forklift trucks, tow tractors and urban delivery vehicles, such as the iconic British milk float which for most of the 20th century made the UK was the world's largest user of electric road vehicles. One of the earliest rechargeable batteries, the nickel-iron battery, was favored by Edison for use in electric cars.

During the last few decades, increased concern over the environmental impact of the petroleum-based transportation infrastructure, along with the spectre of peak oil (being the point in time when the maximum rate of global petroleum extraction is reached, after which the rate of production enters terminal decline) has led to renewed interest in an electric transportation infrastructure. Electric vehicles differ from fossil fuel-powered vehicles in that the electricity they consume can be generated from a wide range of sources, including fossil fuels, nuclear power, and renewable sources such as tidal power, solar power, and wind power or any combination of those. However it is generated, this energy is then transmitted to the vehicle through use of overhead lines, wireless energy transfer such as inductive charging, or a direct connection through an electrical cable wherein it may be stored onboard the vehicle by various techniques including battery, flywheel, or supercapacitors.

Vehicles making use of internal combustion engines can usually only derive their energy from a single or a few sources, which are dominated by non-renewable fossil fuels such as petroleum gas (petrol) and diesel, although ethanol, green diesel, biodiesel, and other biofuels are becoming more common At present there are estimated to be over 600 million vehicles globally, the vast majority of these being petroleum gas or diesel fueled. In 2008 alone over 52 million cars alone were produced from a wide range of manufacturers including BMW, Chrysler, Daewoo, Daihatsu, DaimlerChrysler, Fiat, Ford, General Motors, Honda, Hyundai, Isuzu, Kia, Mazda, Mercedes Benz, Mitsubishi, Nissan, Renault, Scania, Suzuki, Toyota, Volkswagen, and Volvo.

In 1997 Toyota started to sell the Prius, making it the first mass-produced hybrid vehicle, with global sales beginning in 2001. In May 2007, global cumulative Prius sales reached the milestone 1 million vehicle mark, and by June 2010, the Prius reached worldwide cumulative sales reached 2.7 million units. At present the Prius represents 50% of the US sales of hybrid electric vehicles. Hybrid electric vehicles combine a conventional (usually fossil fuel-powered) power train with some form of electric propulsion. An advantage of electric or hybrid electric vehicles is that they can take advantage of techniques such as regenerative braking and suspension to recover energy normally lost during braking as electricity to be restored to the on-board battery. Regenerative braking mechanisms typically consist of a motor controller and an electrical motor that can reduce a vehicle's speed.

Hybrid electric vehicles are typically classified according to the way in which power is supplied to the drive train, including parallel hybrids where the internal combustion engine (ICE) and electric motor are both connected to the mechanical transmission and can simultaneously transmit power to drive the wheels. Current, commercialized parallel hybrids use a single, small (<20 kW) electric motor and small battery pack as the electric motor is not designed to be the sole source of motive power from launch. Parallel hybrids are more efficient that comparable non-hybrid vehicles especially during urban stop-and-go conditions and at times during highway operation where the electric motor is permitted to contribute.

In series hybrids only the electric motor drives the drive train and the ICE works as a generator to power the electric motor or to recharge the batteries. The battery pack can recharged from regenerative braking and from the ICE. Series hybrids usually have a smaller combustion engine but a larger battery pack as compared to parallel hybrids, which makes them more expensive, but more efficient in city driving. Power-split hybrids have the benefits of a combination of series and parallel characteristics and as a result are more efficient overall, because series hybrids tend to be more efficient at lower speeds and parallel tend to be more efficient at high speeds. Examples of power-split (referred to be some as “series-parallel”) hybrid power trains include current models of Ford, General Motors, Lexus, Nissan, and Toyota.

Full hybrids are vehicles that can just run on just the engine, just the batteries, or a combination of both and example include Ford's hybrid system, Toyota's Hybrid Synergy Drive and General Motors/Chrysler's Two-Mode Hybrid. A large, high-capacity battery pack is needed for battery-only operation and the vehicles have a split power path that allows more flexibility in the drive train by interconverting mechanical and electrical power, at some cost in complexity. A so-called mild hybrid is a vehicle that cannot be driven solely on its electric motor, because the electric motor does not have enough power to propel the vehicle on its own include some of the features found in hybrid technology, and usually achieve limited fuel consumption savings, typically up to 15 percent in urban driving and 10 percent overall. A mild hybrid is essentially a conventional vehicle with oversize starter motor; allowing the engine to be turned off whenever the car is coasting, braking, or stopped, yet restart quickly and cleanly. The motor is often mounted between the engine and transmission, taking the place of the torque converter, and is used to supply additional propulsion energy when accelerating. Accessories can continue to run on electrical power while the gasoline engine is off, and as in other hybrid designs, the motor can be used for regenerative braking to recapture energy. As compared to full hybrids, mild hybrids have smaller batteries and a smaller, weaker motor/generator, which allows manufacturers to reduce cost and weight.

Additionally, the major vehicle manufacturers including for example Ford, General Motors, Toyota, Mazda, Renault, and Suzuki are also actively researching and developing true electric vehicles for commercial production and sale which exploit only electrical propulsion. These are paralleled by a number of small start-up companies including for example Tesla Motors which produces the Tesla Roadster with a range of 200 miles (320 km) on a single charge and had sold 1,000 units by January 2010, Commuter Cars, Phoenix Motorcars, Miles Electric Vehicles which specializes in fleet type vehicles with limited maximum speed, and Aptera Motors. The majority of these exploiting recent advances in lithium-based battery technology, in large part driven by the consumer electronics industry, that allow full-sized, highway-capable electric vehicles to be propelled as far on a single charge as conventional cars go on a single tank of gasoline. Lithium batteries have been made safe, can be recharged in minutes instead of hours, and now last longer than the typical vehicle. The production cost of these lighter, higher-capacity lithium batteries is gradually decreasing as the technology matures and production volumes increase.

Competitive technologies to lithium-based batteries are lithium electrochemical cells and the whole class of fuel cells based upon electrochemical reactions that convert a source fuel into an electrical current by reactions of the fuel and an oxidant, triggered in the presence of an electrolyte, generating byproducts typically of water and/or carbon dioxide. The reactants flow into the cell, and the reaction products flow out of it, while the electrolyte remains within it. Fuel cells can operate continuously as long as the necessary reactant and oxidant flows are maintained which has provided the spur for their development against battery based systems. However, the most common fuel, hydrogen, introduces requirements for special handling and issues of safety in consumer applications. Accordingly research has focused to allowing other hydrocarbon fuels, including diesel and methanol, together with solid oxide fuel cells (SOFC) “because of a possibility of using a wide variety of fuel” (K. Hayashi et al “Portable solid oxide fuel cells using butane gas as fuel. Solid State Ionics, No. 302 pp. 343-345) allowing them to run on hydrogen, butane, methanol, and other petroleum products. Molten carbonate fuel cells (MCFCs) operate in a similar manner, except the electrolyte consists of a liquid carbonate material. Fuel cells typically are being geared to heavy duty applications such as trucks, busses etc for automobile applications as well as marine applications.

As is evident from regenerative braking and regenerative suspension in hybrid electric vehicles there is benefit in exploiting the energy provided to propel the vehicle to regenerate electricity to recharge the battery (or batteries) of the vehicle. Whilst in dense city and urban environments electric vehicles are expected to be braking frequently, thereby making regenerative braking beneficial as otherwise the vehicles range would be severely reduced. However, in all electric vehicles including hybrid electric vehicles there is no regeneration of electricity during the period of time that the vehicle is being propelled.

It is, therefore, desirable to provide a means of generating electricity whilst the vehicle is in motion.

### SUMMARY OF THE INVENTION

It is an object of the present invention to obviate or mitigate at least one disadvantage of the prior art.

In accordance with an embodiment of the invention there is provided a method comprising:
providing a vehicle having at least a front axle, a rear axle, a battery and an engine;
providing a drive shaft for transmitting rotary motion from the engine to a first gearbox disposed at the rear axle wherein the drive shaft rotates at the same rate as the revolutions per minute of the engine and the first gearbox provides a predetermined scaling between the rotation rate of the drive shaft and that applied to the rear axle; and
providing a generator for generating electricity to charge the battery, a predetermined portion of the generator comprising a predetermined section of the drive shaft.

In accordance with another embodiment of the invention there is provided a method comprising:
providing a vehicle having at least a battery and an engine;
providing a generator for generating an electric current;
providing a gearbox for receiving a rotary output of the engine at a first rate of rotation and converting it to a rotary input at a second rate of rotation for the generator, the first scaling between the first rate of rotation and the second rate of rotation determined by an aspect of the gearbox.

In accordance with another embodiment of the invention there is provided a method comprising:
providing a wheel assembly for a vehicle comprising at least an axle and a hub to which a wheel is attached;
providing a first predetermined rotating portion of a first generator as a predetermined portion of at least one of the axle and the hub;
providing a second predetermined non-rotating portion of the first generator;
operating the vehicle to provide motion and charging a battery of the vehicle from the generator.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of an electric vehicle according to an embodiment of the invention;

FIG. 2A is a schematic of a drive shaft generator for an electric vehicle according to an embodiment of the invention;

FIG. 2B is a schematic of a crank shaft generator for an electric vehicle according to an embodiment of the invention;

FIG. 3 is a schematic of a generator axle for an electric vehicle according to an embodiment of the invention;

FIG. 4 is a schematic of an electric vehicle according to an embodiment of the invention employing multiple axle generators and drive shaft generator;

FIG. 5 is a schematic of an electric vehicle according to an embodiment of the invention employing a drive shaft generator with auxiliary generators;

FIG. 6 is a schematic of an electric vehicle according to an embodiment of the invention employing drive shaft, axle and auxiliary generators;

FIG. 7 is a schematic of an electric vehicle according to an embodiment of the invention employing auxiliary generators;

FIG. 8 is a schematic of auxiliary generators coupled to the gearbox of an electric vehicle according to an embodiment of the invention;

FIG. 9 is a schematic of auxiliary generators coupled to the gearbox of an electric vehicle according to an embodiment of the invention;

FIG. 10 is a schematic of a modified drive shaft employing multiple generators for an electric vehicle according to an embodiment of the invention; and

FIG. 11 is a schematic of an electric vehicle according to an embodiment of the invention employing hub mounted generators.

### DETAILED DESCRIPTION

The present invention is directed to generating electricity for storage within batteries or other suitable means to recharge the batteries of an electric or hybrid electric vehicle during its propulsion as opposed to during braking.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

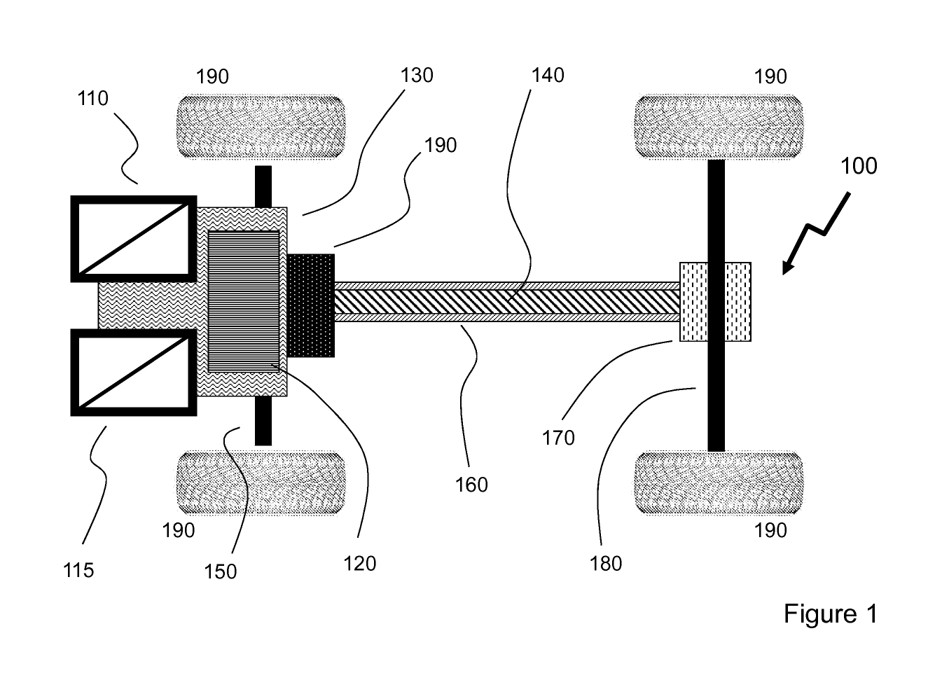

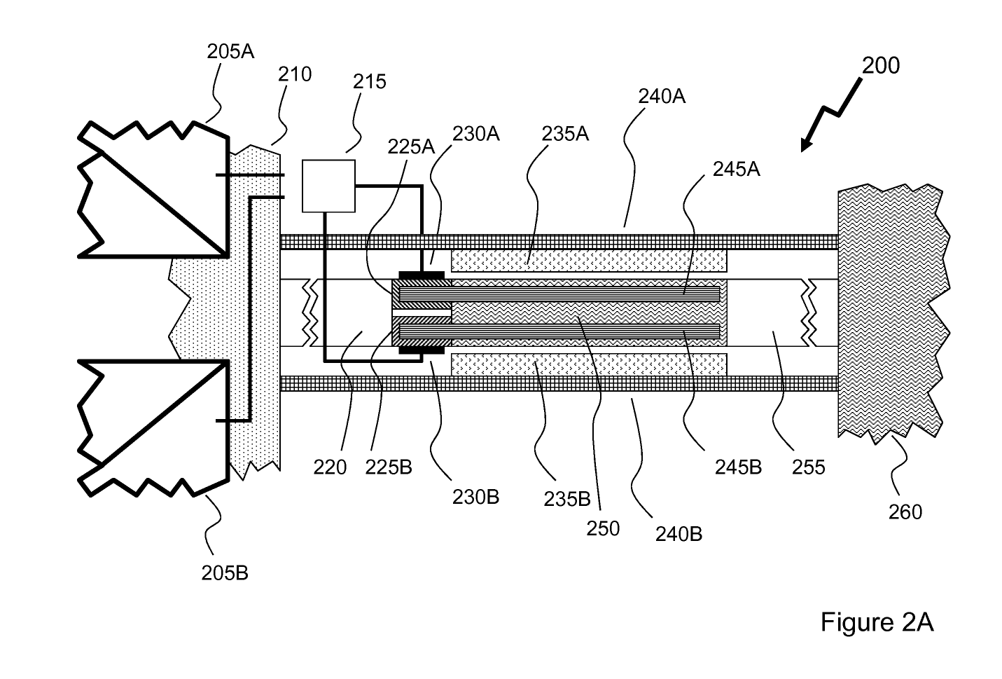

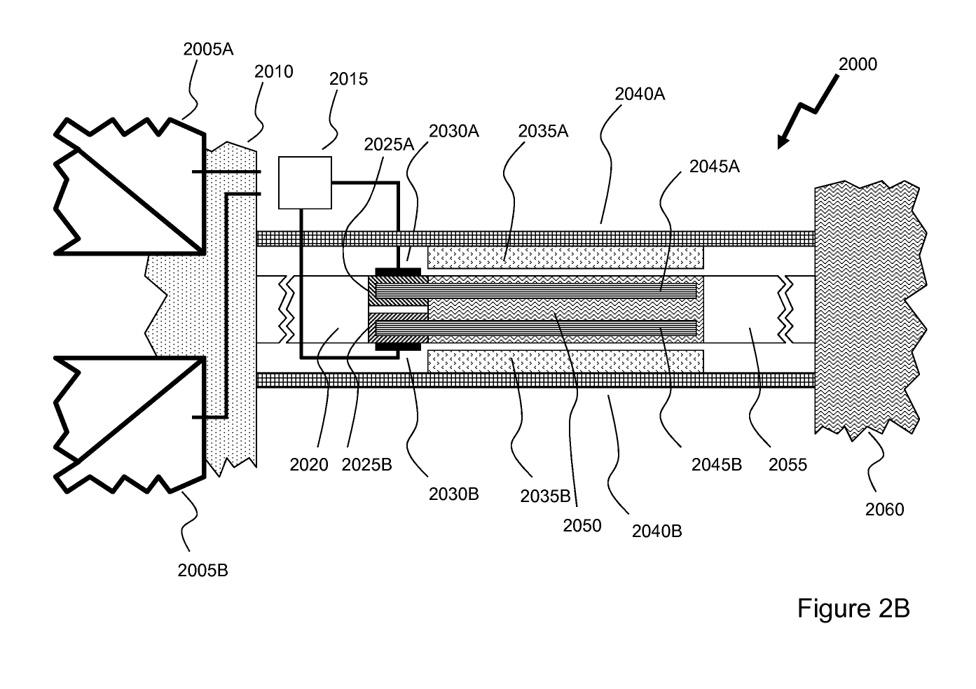

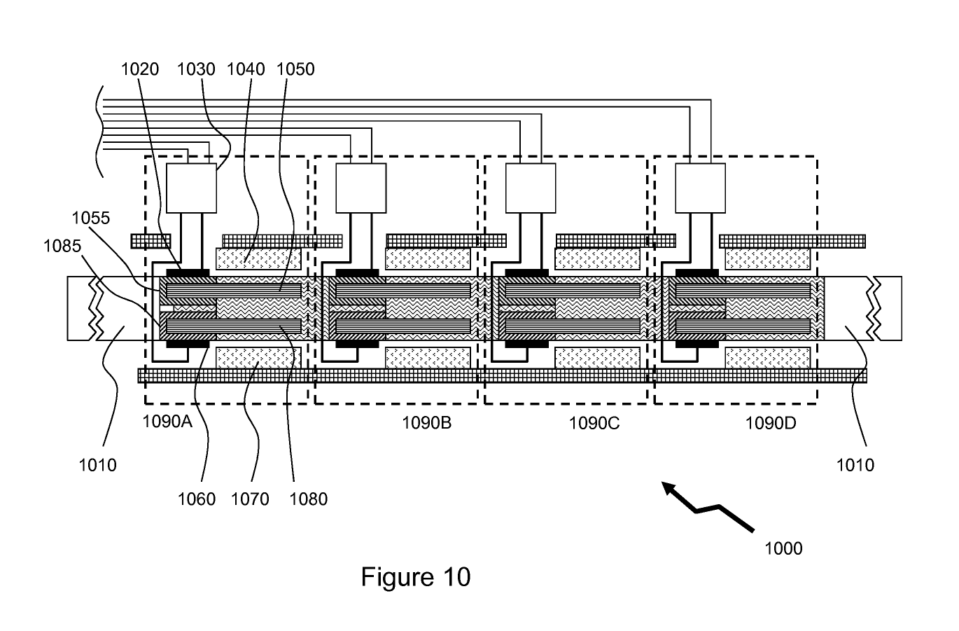

As illustrated in FIG. 1 there is shown a chassis 100 for an electric vehicle according to an embodiment of the invention. As shown the chassis 100 comprises an engine 130, for example a petrol ICE, which engages to drive shaft 140 via drive combiner 190. Also connected to the drive combiner 190 is electric motor 120 which is coupled to primary battery 110 and secondary battery 115. Drive combiner 190 selectively combines the rotary motion of either the crank shaft (not shown for clarity) of engine 130 or rotor shaft (not shown for clarity) of motor 120 to the drive shaft 140. Also coupled to the chassis is front axle 150 and to the drive shaft 140 by rear gearbox 170 is rear axle 180. Attached to front axle 150 and rear axle 180 are wheels 190. In propelling the vehicle of which chassis 100 forms part the hybrid drive, comprising engine 130 and electric motor 120, provide rotary drive to the drive shaft 140 via the drive combiner 190 to the rear gearbox 170 therein driving the rear axle 180. However, according to this embodiment of the invention, as will be expanded further below in respect of FIGS. 2 and 10 the drive shaft 140 is replaced with a generating drive shaft such that rotary motion of the drive shaft 140 in conjunction with outer body 160 provides generation of electricity that is selectively coupled to one or both of the primary battery 110 and secondary battery 115.

It would be evident to one skilled in the art that the resulting generator comprising drive shaft 140 in conjunction with outer body 160 would produce electricity during all forward or backwards motion of the vehicle of which it forms part. Further when the electric motor 120 is engaged and is being provided electricity from the first battery 110 then the second battery 115 may be recharged or vice-versa. Optionally the charging may be switched periodically to keep both batteries as fully charged as possible given the current used and recharging current. Alternatively when the engine 130 is providing all the propulsion then both batteries may be recharged simultaneously. It would also be evident that the usage of engine 130 may be reduced or the vehicle range increased as the electric motor 120 may be employed more frequently and with in-use recharging will not discharge as quickly.

Now referring to FIG. 2A there is shown a schematic of a drive shaft generator 200 for an electric vehicle according to an embodiment of the invention. As shown there are first and second batteries 205A and 205B that are coupled to a motor, not shown for clarity, and a charging director 215. The motor, and in some embodiments an engine which is also not shown for clarity, are connected to the gearbox 210 that drives a first element of an overall drive shaft, this being first shaft 220 that connects to second shaft 250 and therein to third shaft 255 which is coupled to axle gearbox 260. Disposed on first shaft 220 are first commutator 225A and second commutator 225B that are connected to the charging director 215 through first and second commutator contacts 230A and 230B respectively. Connected to first commutator 225A is first coil portion 245A that is disposed onto second shaft 250, and connected to second commutator 225B is second coil portion 245B that is similarly disposed onto second shaft 250.

Second shaft 250 is disposed between first magnet 235A and second magnet 235B, which provide the magnetic field within which the coil, formed from at least first coil portion 245A and second coil portion 245B rotates to generate the electric potential and therein current. The first commutator 225A and second commutator 225B mean that the output is a DC current from the drive shaft generator 200 to the charging director 215 and therein to one or both of the first and second batteries 205A and 205B respectively.

It would also be evident that since the electrical potential, and hence current for a fixed load, generated in a generator is proportional to the number of turns of the electrical coil rotating within the magnetic field (N) and the rate of change of the magnetic field seen by the electric coil (δψ/δt) that the drive shaft generator 200 may be designed in varying configurations. For example usually the high rotation rate of an ICE engine that operates over a range of 600 to about 7000 revolutions per minute (rpm), though this varies according to engine design aspects such as cylinder capacity, number of cylinders, cylinder configuration etc and is typically less for diesel engines, is converted through a gearbox positioned close to the ICE engine to the drive shaft rotations as the vehicle's wheels rotate between 0 rpm to around a maximum of 1800 rpm.

Therefore in one possible embodiment the number of turns is increased in the drive shaft generator 200 that operates with the drive shaft rotating at the reduced rate from the gearbox or the gearbox is displaced within the vehicle for example allowing the drive shaft generator 200 to operate at the higher rotation rate of the engine before the gearbox reduces the rotation rate for driving the wheels through an axle connected to the output of the gearbox. Accordingly, there is benefit to adjusting the normal configuration of the chassis and drive train to position the gearbox to the rear of the vehicle and operating the vehicle with rear wheel drive.

Now referring to FIG. 2B there is shown a schematic of an auxiliary shaft generator 2000 for an electric vehicle according to an embodiment of the invention. As shown there are first and second batteries 2005A and 2005B that are coupled to a motor, not shown for clarity, and a charging director 2015. The motor, and in some embodiments an engine which is also not shown for clarity, are connected through gearbox 2010 that drives a first element of an overall crank shaft, this being first crank 2020 that connects to second crank 2050 and therein to third crank 2055. Disposed on first crank 2020 are first commutator 2025A and second commutator 2025B that are connected to the charging director 2015 through first and second commutator contacts 2030A and 2030B respectively. Connected to first commutator 2025A is first coil portion 2045A that is disposed onto second crank 2050, and connected to second commutator 2025B is second coil portion 2045B that is similarly disposed onto second crank 2050. The crank shaft rather than terminating within the gearbox 20010 or shortly thereafter as with conventional designs now runs for an extended length with the end of the overall crank shaft, being third crank 2060, mounted to crank mount 2060.

Second crank 2050 is disposed between first magnet 2035A and second magnet 2035B, which provide the magnetic field within which the coil, formed from at least first coil portion 2045A and second coil portion 2045B rotates to generate the electric potential and therein current. The first commutator 2025A and second commutator 2025B mean that the output is a DC current from the auxiliary shaft generator 2000 to the charging director 2015 and therein to one or both of the first and second batteries 2005A and 2005B respectively.

It would also be evident that since the electrical potential, and hence current for a fixed load, generated in a generator is proportional to the number of turns of the electrical coil rotating within the magnetic field (N) and the rate of change of the magnetic field seen by the electric coil (δΦ/δt) that the crank shaft generator 2000 may be designed in varying configurations. For example usually the high rotation rate of an ICE engine that operates over a range of 600 to about 7000 revolutions per minute (rpm), though this varies according to engine design aspects such as cylinder capacity, number of cylinders, cylinder configuration etc and is typically less for diesel engines, is converted through a gearbox positioned close to the ICE engine to the drive shaft rotations as the vehicle's wheels rotate between 0 rpm to around a maximum of 1800 rpm.

Therefore in one possible embodiment the auxiliary shaft, formed from first crank 2020, second crank 2050, and third crank 2055, is connected to the crank shaft of the engine within the gearbox so that the auxiliary shaft generator 2000 operates with the crank shaft rotating at higher rate than the crank shaft of the engine. In this manner the gearbox, whilst modified to provide gearing for the drive shaft and auxiliary shaft may be disposed in a conventional position close to the engine allowing front wheel drive configurations as well as rear wheel drive and all-wheel drive configurations.

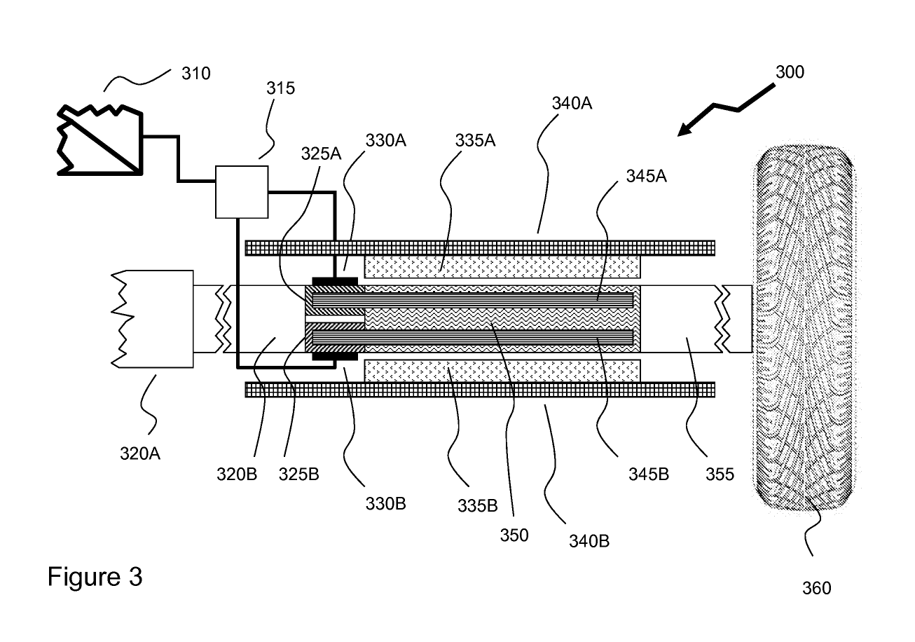

Referring to FIG. 3 there is shown a schematic of a generator axle 300 for an electric vehicle according to an embodiment of the invention. As shown a wheel 360 is connected via an axle, comprising first portion 320B, second portion 350, and third portion 355 to differential 320A which connects to the drive shaft, not shown for clarity, of the vehicle. Disposed on first portion 320B are first commutator 325A and second commutator 325B that are connected to the charging director 315 through first and second commutator contacts 330A and 330B respectively. Connected to first commutator 325A is first coil portion 345A that is disposed onto second portion 350, and connected to second commutator 325B is second coil portion 345B that is similarly disposed onto second crank 350.

Second crank 350 is disposed between first magnet 335A and second magnet 335B, which provide the magnetic field within which the coil, formed from at least first coil portion 345A and second coil portion 345B rotates to generate the electric potential and therein current. The first commutator 325A and second commutator 325B mean that the output is a DC current from the generator axle 300 to the charging director 315 and therein to the battery 310.

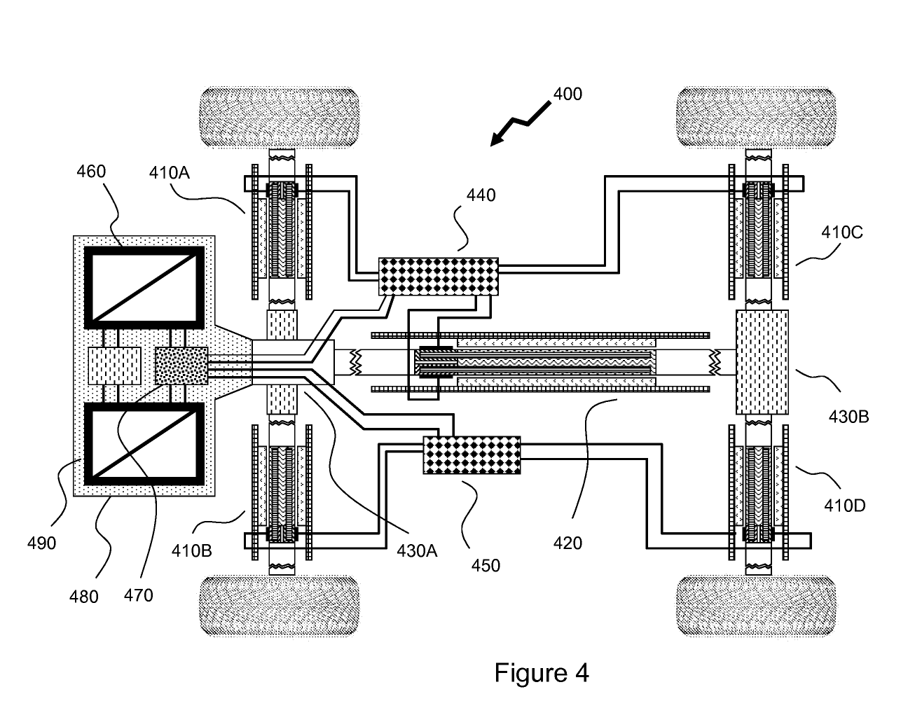

Now referring to FIG. 4 there is shown chassis 400 for an electric vehicle according to an embodiment of the invention employing multiple axle generators 410A through 410D and drive shaft generator 420. As shown engine 480 is connected to a drive shaft through a gearbox, neither identified for clarity, to front differential 430A and rear differential 430B. From the front differential 430A first and second drive axle assemblies 410A and 410B are connected to provide the front axle, whilst the rear differential 430B connects to third and fourth drive axle assemblies 410C and 410D respectively. Each of the four drive axle generators 410A through 410D respectively being for example of a construction similar to that of generator axle 300 in FIG. 3 respectively.

First and third drive axle assemblies 410A and 410C are connected to first charging circuit 440 and therein to charge director 470 that directs the charging current to either the first battery 460 or second battery 490. Second and fourth drive axle assemblies 410B and 410D are connected to second charging circuit 450 and therein to charge director 470. It would be evident to one skilled in the art that where engine 480 is an ICE engine and the electric motor, not shown for clarity, is not engaged that the charge director 470 may direct charge to both batteries simultaneously but wherein the electric motor is operating then the charging may be to one of the two batteries whilst the other provides power for propulsion. Optionally engine 480 is only an electric motor for a pure electric vehicle rather than a hybrid electric vehicle.

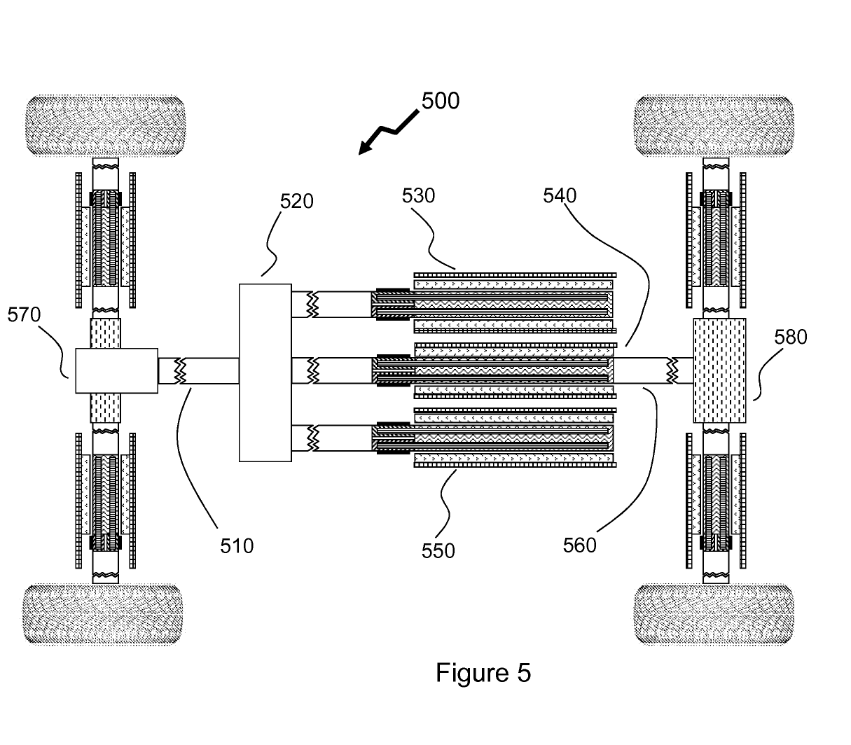

Now referring to FIG. 5 is a schematic 500 of an electric vehicle according to an embodiment of the invention employing a drive shaft generator 540 with first and second auxiliary generators 530 and 550 respectively. As shown drive shaft 510 from front differential 570 couples to splitter 520, from which drive shaft generator 540 is coupled which couples to second drive shaft 560 and therein to the rear differential 580. Drive shaft generator 540 for example being constructed as per drive shaft generator 200 of FIG. 2. Also coupled to splitter 520 are first and second auxiliary generators 530 and 550 respectively which may be similarly implemented as per drive shaft generator 200 of FIG. 2. Alternatively first and second auxiliary generators 530 and 550 respectively may be driven from the splitter 520 with an increased rotation rate to that of drive shaft generator 540. Optionally splitter 520 may provide a gear option for the first and second auxiliary generators 530 and 550 so that they are operating at high rotation rates even at low rpm for the drive shaft 510 from the engine.

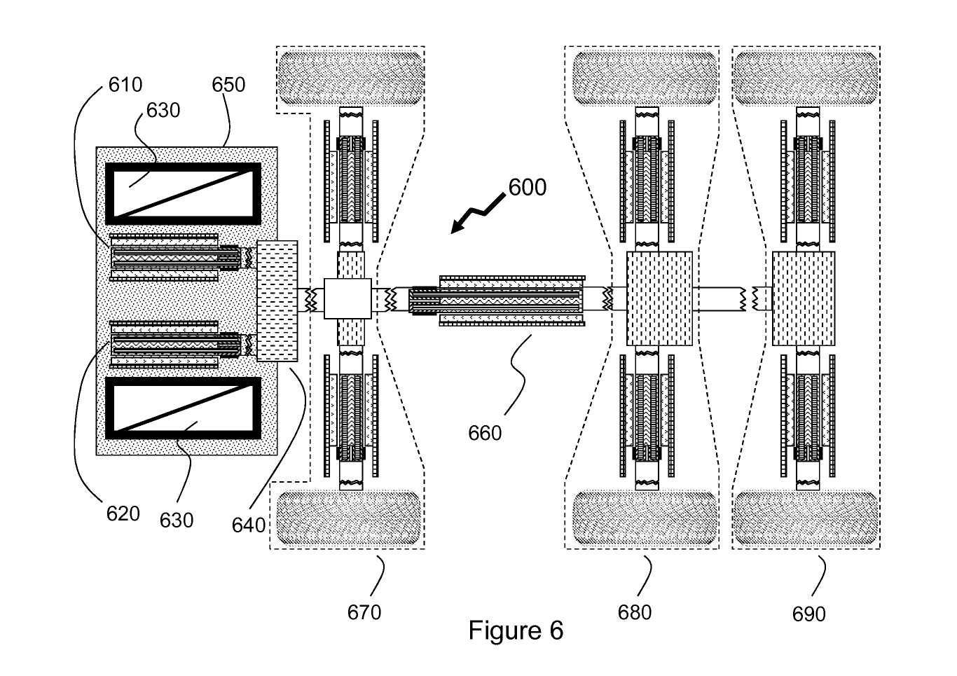

Now referring to FIG. 6 there is a schematic 600 for an electric vehicle according to an embodiment of the invention employing drive shaft generator 660, axle generators and first and second auxiliary generators 610 and 620 respectively. Accordingly an engine 650 provides rotary drive to a drive shaft that runs the length of the chassis of the electric vehicle. The electric vehicle comprises a single front axle 670 with a pair of axle generators, not identified for clarity but shown, and a pair of rear axles 680 and 690 respectively, each again with a pair of axle generators. The axle generators each being for example a generator axle 300, as shown in FIG. 3. Disposed between the front axle 670 and first rear axle 680 is a drive shaft generator 660 implemented for example as per drive shaft generator 200 of FIG. 2. Also coupled to the engine 650 is auxiliary gearing 640 that provides rotary motion to the first and second auxiliary generators 610 and 620 respectively which may be implemented as variations of either drive shaft generator 200 or auxiliary shaft generator 2000 of FIGS. 2A and 2B respectively. All of the generators provide electric charge for the batteries 630.

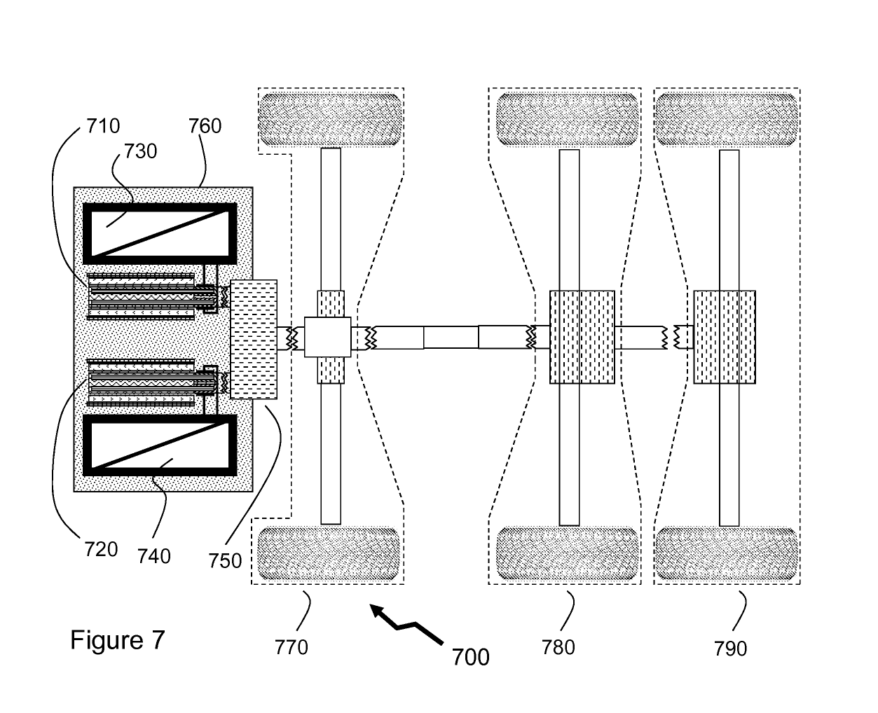

Now referring to FIG. 7 is a schematic 700 of an electric vehicle according to an embodiment of the invention employing first and second auxiliary generators 710 and 720 respectively which are coupled to auxiliary gearing 750 that is driven from the engine 760 which may be an ICE, electric motor, or a hybrid. The first and second auxiliary generators 710 and 720 coupled to first and second batteries 730 and 740 respectively. In schematic 700 as opposed to schematic 600 the front axle 770 and first and second rear axles 780 and 790 respectively do not comprise generators. The first and second auxiliary generators 710 and 720 respectively may be implemented for example as variations of either drive shaft generator 200 or auxiliary shaft generator 2000 of FIGS. 2A and 2B respectively.

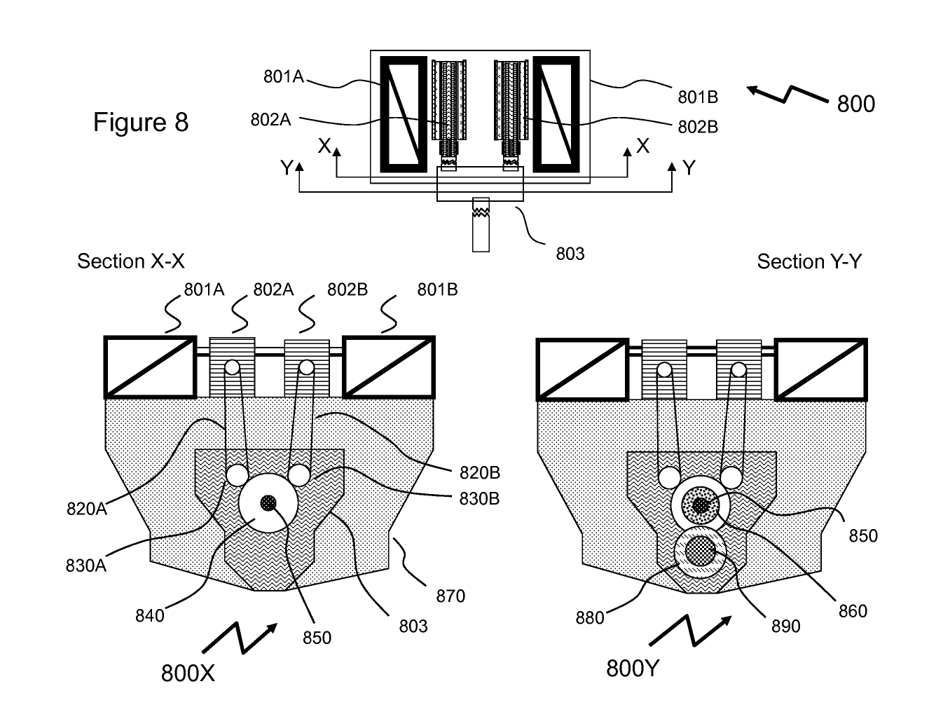

Referring to FIG. 8 there is shown a schematic 800 of first and second generators 802A and 802B that recharge batteries 801A and 801B and are coupled to the gearbox 803 of an electric/hybrid vehicle according to an embodiment of the invention. Shown in schematic 800 are first section X-X and second section Y-Y which are shown in first and second views 800X and 800Y respectively. Considering first view 800X which represents cross-section X-X of schematic 800, there is shown an engine 870 which is coupled to gearbox 803 via crankshaft 850. Coupled to the crankshaft 850 within the gearbox 860 is gear 840 that engages first and second generator gears 830A and 830B respectively. Disposed atop the engine 870 are first and second generators 802A and 802B respectively that are connected to the first and second generator gears 830A and 830B respectively by first and second belts 820A and 820B respectively. In this manner the crankshaft 850 rotation is transferred to the first and second generators 802A and 820B respectively such that they generate electricity to charge the first and second batteries 801A and 801B respectively.

Referring now to second view 800Y which represents cross-section Y-Y of schematic 800, there is shown crankshaft 850 that is engaged with first gear 860 and therein to drive gear 880 which is connected to the driveshaft 890. As such rotary motion of the crankshaft 850 is provided to the driveshaft 890 based upon the ratio of the first gear 860 and drive gear 880. It would be evident to one skilled in the art that a gearbox 803 would normally provide multiple first gears 860 and drive gears 880 to provide the required ratios for the multiple gears which are selected either automatically or manually. As such the gearbox 803 in FIG. 8 provides for driving the generators that recharge the batteries all the time that the engine 870 is on and hence the crankshaft 850 is rotating. It would also be evident that the gearing of gear 840 and first and second generator gears 830A and 830B may be selected to provide a high rate of change δΦ/δt to maximize generation of electricity for recharging the battery or batteries. It would also be evident to one skilled in the art that just as a plurality of first gears 860 and drive gears 880 may be provided that a plurality of gears 840 and generator gears 830A/830B may be provided so that the generators are operating within a predetermined range under varying crankshaft 850 rotation rates. Hence, at low speeds with low engine rpm the gearing ratio to the generator may be high to achieve a high rpm on the generator but this gearing ratio may be lowered at higher speeds where the engine rpm is higher.

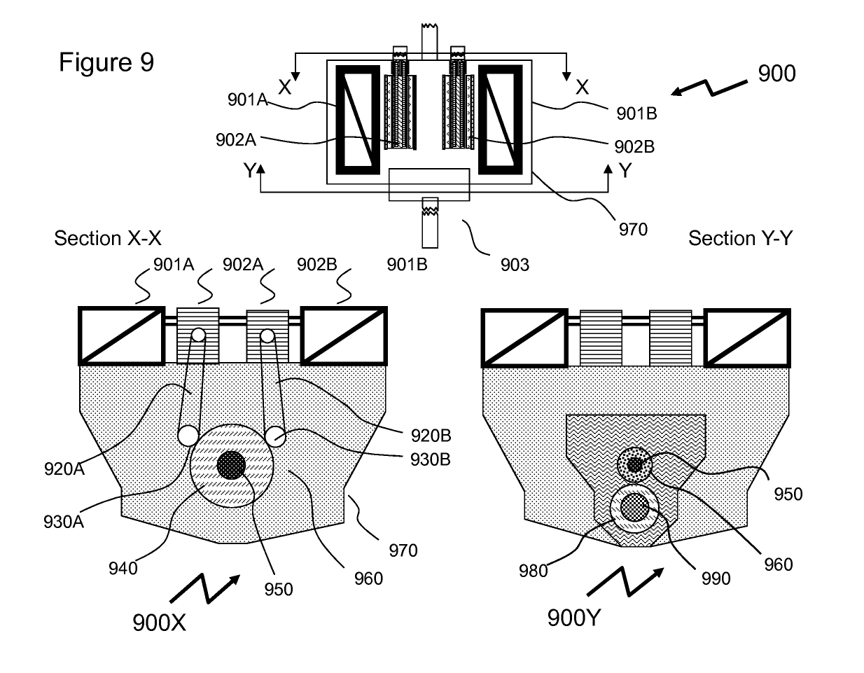

Referring now to FIG. 9 there is shown a schematic 900 of auxiliary generators coupled to an engine of an electric vehicle according to an embodiment of the invention. As shown in schematic 900 first and second generators 902A and 902B are disposed in respect to an engine 970 that recharge batteries 901A and 901B and are not coupled to the gearbox 803 of an electric/hybrid vehicle according to an embodiment of the invention. Shown in schematic 900 are first section X-X and second section Y-Y which are shown in first and second views 900X and 900Y respectively. Considering first view 900X which represents cross-section X-X of schematic 900, there is shown an engine 970 which has a crankshaft 950 with gear 840 coupled to it that engages first and second generator gears 930A and 930B respectively. Disposed atop the engine 970 are first and second generators 902A and 902B respectively that are connected to the first and second generator gears 930A and 930B respectively by first and second belts 920A and 920B respectively. In this manner the crankshaft 950 rotation is transferred to the first and second generators 902A and 920B respectively such that they generate electricity to charge the first and second batteries 901A and 901B respectively.

Referring now to second view 900Y which represents cross-section Y-Y of schematic 900, there is shown crankshaft 950 that is engaged with first gear 960 and therein to drive gear 980 which is connected to the driveshaft 990. As such rotary motion of the crankshaft 950 is provided to the driveshaft 990 based upon the ratio of the first gear 960 and drive gear 980. It would be evident to one skilled in the art that a gearbox 903 would normally provide multiple first gears 960 and drive gears 980 to provide the required ratios for the multiple gears which are selected either automatically or manually. It would also be evident to one skilled in the art that just as a plurality of first gears 960 and drive gears 980 may be provided that a plurality of gears 940 and generator gears 930A/930B may be provided so that the generators are operating within a predetermined range under varying crankshaft 950 rotation rates. Hence, at low speeds with low engine rpm the gearing ratio to the generator may be high to achieve a high rpm on the generator but this gearing ratio may be lowered at higher speeds where the engine rpm is higher. Accordingly this generator gearbox with plurality of gears 940 and generator gears 930A/930B may be changed out of synchronization with gearbox 903.

Referring to FIG. 10 there is depicted a schematic 1000 of a modified shaft 1010 employing multiple generators 1090A through 1090D for an electric vehicle according to an embodiment of the invention. As shown modified shaft 1010 has disposed along it four generators 1090A through 1090D that provide electricity to recharge the batteries of an electric or hybrid electric vehicle, not shown for clarity. Each of the generators 1090A through 1090D comprises a coil formed from first segment 1050 and second segment 1080 that are disposed between first magnet pole 1040 and second magnet pole 1070. First segment 1050 being electrically connected to first contact 1055 and second segment 1080 being electrically connected to second contact 1085. As the modified shaft 1010 rotates then each of first contact 1055 and second contact 1085 engage alternately first commutator 1055 and second commutator 1085 such that the current generated within the multiple generators 1090A through 1090D is direct current rather than alternating current.

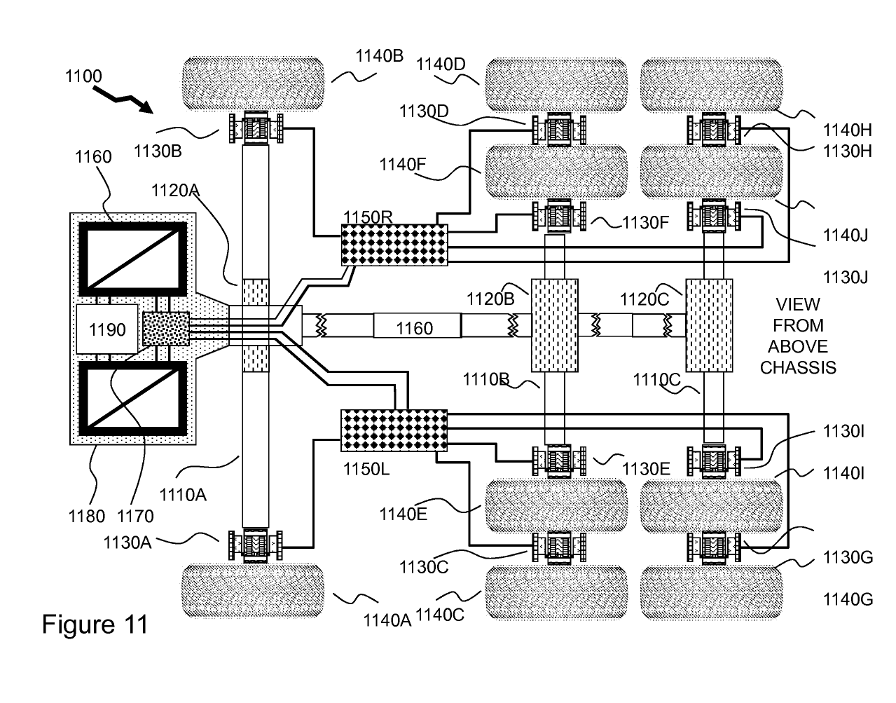

Referring to FIG. 11 there is shown a schematic 1100 of an electric vehicle according to an embodiment of the invention employing hub generators 1130A through 1130J. Schematic 1100 shows a chassis for a truck comprising an engine 1180 that has housed in association with it batteries 1160, power module 1190 for directing charge from the batteries 1160 to engine 1180 and charging director 1170 for charging the batteries 1160 with the current generated from the hub generators 1130A through 1130J. From the engine 1180 a driveshaft 1160 engages first, second and third differentials 1120A, 1120B and 1120C respectively to drive first, second, and third axles 111A, 1110B and 1110C respectively. Attached to first axle 1110A are front left tire 1140A with first hub generator 1130A and front right tire 1140B with second hub generator 1130B. Attached to second axle 1110B are first through fourth rear tires 1140C through 1140F respectively with respective third through sixth hub generators 1130C through 1130F. Attached to third axle 1110C are fifth through eighth rear tires 1140G through 1140) respectively with respective seventh to tenth hub generators 1130G through 1130J.

Further as shown the generators on the right side of the electric vehicle are coupled to first charging circuit 1150R which is in turn connected to charging director 1170. Also connected to charging director 1170 is second charging circuit 1150L which is connected to the generators on the left side of the electric vehicle. It would be apparent to one skilled in the art that other configurations of charging circuit, batteries, generators, and charging director are possible without departing from the scope of the invention. For example the generators on the left side of the electric vehicle may charge one battery only or a subset of a plurality of batteries, whilst those on the right side charging the other battery or remainder of the batteries.

Within the embodiments presented supra in respect of FIGS. 1 through 11 above that the generator elements have been presented with fixed magnets and rotating coils. It would be evident to one skilled in the art that the generators may alternatively employ fixed coils and rotating magnets. Similarly the embodiments are described in respect of a single drive shaft from the engine but it would be evident to one skilled in the art that multiple drive shafts may be provided from the engine or that the engine may be disposed towards the middle of the vehicle and drive shaft(s) is provided to the front and the rear of the vehicle.

The above-described embodiments of the present invention are intended to be examples only. Alterations, modifications and variations may be effected to the particular embodiments by those of skill in the art without departing from the scope of the invention, which is defined solely by the claims appended hereto

What is claimed is:

1. A method comprising:
providing a vehicle having at least a front axle, a rear axle, a battery and an engine;
providing a drive shaft for transmitting rotary motion from the engine to a first gearbox disposed at the rear axle wherein the drive shaft rotates at the same rate as the revolutions per minute of the engine and the first gearbox provides a predetermined scaling between the rotation rate of the drive shaft and that applied to the rear axle; and
providing a generator for generating electricity to charge the battery, a predetermined portion of the generator comprising a predetermined section of the drive shaft.

2. The method according to claim 1 wherein;
providing the predetermined section of the drive shaft comprises providing at least one of a magnet and a turn of wiring to form a coil as a predetermined portion of the predetermined section of the drive shaft.

3. The method according to claim 1 further comprising;
providing a charging circuit electrically disposed between the battery and generator to control charging of the battery in dependence upon at least an aspect of at least one of the engine and the battery.

4. The method according to claim 1 wherein,
the charging circuit provides for at least one of direct current charging and pulsed charging of the battery.

5. The method according to claim 1 further comprising;
a second gearbox disposed at the front axle to provide a predetermined scaling between the rotation rate of the drive shaft and that applied to the front axle.

6. The method according to claim 1 further comprising:
providing another generator for generating electricity to charge the battery wherein the another generator is also connected to the drive shaft.

7. A method comprising:
providing a vehicle having at least a battery and an engine;
providing a generator for generating an electric current; and
providing a first gearbox for receiving a rotary output of the engine at a first rate of rotation and converting it to a rotary input at a second rate of rotation for the generator, the gearbox characterised by a first scaling setting the ratio between the first rate of rotation and the second rate of rotation; wherein the first gearbox is at least one of a predetermined portion of a second gearbox and disposed between the engine and a second gearbox, the second gearbox coupling the engine to a drive shaft of the vehicle.

8. The method according to claim 7 wherein,
the first scaling is determined in dependence upon at least an aspect of the generator, an aspect of the battery, and an aspect of the engine.

9. The method according to claim 7 wherein,
providing the first gearbox comprises providing also for the driving of a driveshaft connected to an axle of the vehicle to provide propulsion for the vehicle.

10. The method according to claim 9 wherein,
the aspect of the first gearbox provides for at least one of a constant first scaling and a variable first scaling.

11. The method according to claim 10 wherein,
the aspect of the first gearbox provides for variable first scaling and the variable first scaling changes according to the setting of the gearbox with respect to driving the driveshaft.

12. The method according to claim 11 wherein,
the first gearbox is connected to the drive shaft and is other than a gearbox for controlling a drive shaft of the vehicle.

13. A method comprising:
providing a wheel assembly for a vehicle comprising at least an axle and a hub to which a wheel is attached;
providing a first predetermined rotating portion of a first generator as a predetermined portion of at least one of the axle and the hub;
providing a second predetermined non-rotating portion of the first generator; and
operating the vehicle to provide motion and charging a battery of the vehicle from the generator.

14. The method according to claim 13 wherein;
providing the first predetermined rotating portion of the generator comprises providing at least one of a magnet and a coil as a predetermined portion of the at least one of the axle and the hub.

15. The method according to claim 13 further comprising;
providing a second generator wherein a first predetermined rotating portion of the second generator is a predetermined portion of the other of the axle and the hub.

16. The method according to claim 13 further comprising;
providing a second generator wherein a first predetermined rotating portion of the second generator is a predetermined portion of a drive shaft of the vehicle.
